(19) United States
(12) Patent Application Publication
(10) Pub. No.: US 2013/0152874 A1
(43) Pub. Date: Jun. 20, 2013

(54) ANIMAL PROCESSING CRADLE

(71) Applicants: Benjamin E. Waldbeser, Milford, IN (US); Debra A. Skevington, Milford, IN (US)

(72) Inventors: Benjamin E. Waldbeser, Milford, IN (US); Debra A. Skevington, Milford, IN (US)

(21) Appl. No.: 13/330,475

(22) Filed: Dec. 19, 2011

(51) Int. Cl. A01K 15/04

(52) U.S. Cl. 119/752

(57) ABSTRACT

The present invention is an animal processing cradle that includes an aluminum crossing support structure with a top portion and a plurality of ends and a support sheet that is sewn over the top portion of the crossing support structure to form a permanent attachment to the top portion of the crossing support structure. The animal processing cradle also includes a hook and loop fastener to secure the animal's neck to the animal processing cradle and a plurality of rubber support caps that are disposed on the ends of the crossing support structure to prevent the animal processing cradle from slipping or sliding, while being set on a surface.

### TECHNICAL FIELD & BACKGROUND

When an individual acquires a new pet, it may be necessary for the pet to receive shots to be compliant with local laws. Veterinarians or farmers may find it difficult to vaccinate or tag the ear of a pet, a fawn or a puppy or vaccinate another animal without assistance.

The present invention generally relates to a transport cradle. More specifically, the invention is an animal transport cradle.

It is an object of the invention to provide an animal processing cradle that secures and holds a fawn, a pet or other animal so that animal can be vaccinated or ear tagged.

It is an object of the invention to provide an animal processing cradle that can be easily folded-up for relatively easy transport while not in use.

It is an object of the invention to provide an animal processing cradle that secures and holds a fawn, a pet or other animal so that animal can be vaccinated or ear tagged without putting a relatively large amount of stress on the animal being vaccinated or ear tagged.

What is really needed is an animal processing cradle that secures and holds a fawn, a pet or other animal so that animal can be vaccinated or ear tagged without putting a relatively large amount of stress on the animal being vaccinated or ear tagged that can be easily folded-up for relatively easy transport while not in use.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates an animal processing cradle in a closed position, in accordance with one embodiment of the present invention.

FIG. 1B illustrates an animal processing cradle in an open position, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

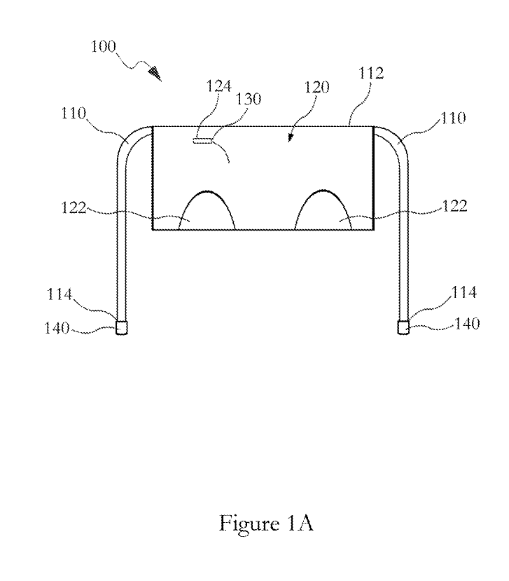

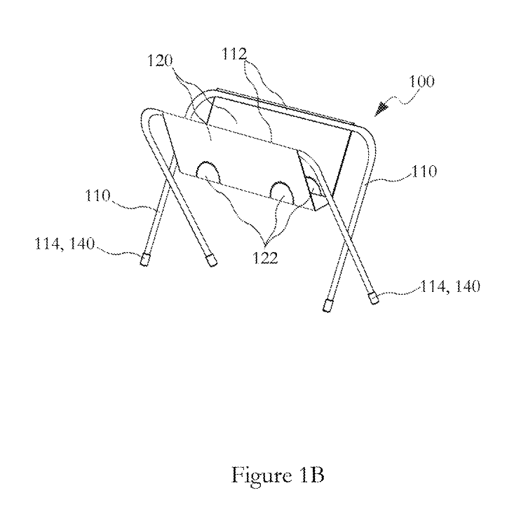

FIG. 1A illustrates an animal processing cradle 100 in a closed position, in accordance with one embodiment of the present invention. The animal processing cradle secures and holds a fawn, a pet or other animal so that animal can be vaccinated or ear tagged without putting a relatively large amount of stress on the animal being vaccinated or ear tagged that can be easily folded-up for relatively easy transport while not in use.

The animal processing cradle 100 has a crossing support structure 110, a support sheet 120, a hook and loop fastener 130 and a plurality of support caps 140. The crossing support structure 110 forms an x-shaped support structure that can be folded inward or outward as desired. The crossing support structure 110 is typically made of heavy gauge aluminum tubing but can be made of other suitable materials as well. The support sheet 120 is sewn over the top portion 112 of the crossing support structure 110 to form a permanent attachment to the top portion 112 of the crossing support structure 110 that is disposed across the top portion 112 of the crossing support structure 110. The support sheet 120 also includes 4 apertures 122 positioned to approximate the position of an animal's legs that are placed through the 4 apertures 122 to help secure the animal in the animal processing cradle 100. A corresponding pair of slits 124 is disposed on the support sheet as well. The support sheet 120 is typically made of heavy vinyl material but can be made of other suitable material as well. A hook and loop fastener 130 that is a hook and loop strap 132 is inserted through the corresponding pair of slits 124 to comfortably and securely secure an animal's neck that is being transported by the animal processing cradle 100. The support caps 140 are disposed on the ends 114 of the crossing support structure 110 to prevent the animal processing cradle 100 from slipping or sliding, while being set on a surface such as a ground surface. The support caps 140 are made of rubber material but can be made of any suitable material.

FIG. 1B illustrates an animal processing cradle 100 in an open position, in accordance with one embodiment of the present invention. The animal processing cradle 100 includes the same elements as described and illustrated in FIG. 1A and its description such as a crossing support structure 110, a support sheet 120, a hook and loop fastener 130 and a plurality of support caps 140 and their auxiliary features. The animal processing cradle 100 illustrated in FIG. 1B is illustrated in an open position that can receive an animal to be secured and/or transported, in contrast to the animal processing cradle 100 illustrated in FIG. 1A which is illustrated in a closed position.

The animal processing cradle provides a safe place for small pets and farm animals to be tagged or vaccinated. Made of heavy gauge aluminum tubing that is formed in an X-shape support structure, the animal processing cradle “fold 'n go” feature is approximately 35″ long by 4″ wide and 30″ high when extended, that includes two bolts and washers connected in supporting the locknut. The rust-free item is covered in vinyl material that measures approximately 20″ by 30″ and can be cut, but does not rip under proper use. Simply place the animal's legs through each of the corresponding apertures and fold-up to cradle the animal and the user is then afforded the ability to trim the nails, vaccinate or treat an injured or ill pet or animal, without struggling to hold them which may cause undue stress on the animal. Farmers and pet owners are among the many people who may find the animal processing cradle convenient and easy to use. The animal processing cradle features a folding mechanism with four leg openings to help secure the pet or animal.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. An animal transport cradle, comprising:
a crossing support structure with a top portion and a plurality of ends;
a support sheet that is sewn over said top portion of said crossing support structure to form a permanent attachment to said top portion of said crossing support structure;
a hook and loop fastener to secure said animal's neck to said animal transport cradle; and
a plurality of support caps that is disposed on said ends of said crossing support structure to prevent said animal processing cradle from slipping or sliding, while being set on a surface.

2. The animal processing cradle according to claim 1, wherein said crossing support structure is made of aluminum.

3. The animal processing cradle according to claim 2, wherein said crossing support structure is made of heavy gauge aluminum tubing.

4. The animal processing cradle according to claim 1, wherein said support sheet is disposed across said top portion of said crossing support structure.

5. The animal processing cradle according to claim 1, wherein said support sheet includes 4 apertures positioned to approximate a position of a plurality of an animal's legs that are placed through said 4 apertures to help secure said animal in said animal transport cradle.

6. The animal according to claim 1, wherein a corresponding pair of slits is disposed on said support sheet.

7. The animal processing cradle according to claim 1, wherein said hook and loop fastener is a hook and loop strap.

8. The animal processing cradle according to claim 7, wherein said hook and loop strap is inserted through said corresponding pair of slits to comfortably and securely secure said animal's neck that is being transported by said animal transport cradle.

9. The animal processing cradle according to claim 1, wherein said support caps are made of rubber material.

10. The animal processing cradle according to claim 1, wherein said surface is a ground surface.

11. An animal transport cradle, comprising:
an aluminum crossing support structure with a top portion and a plurality of ends;
a support sheet that is sewn over said top portion of said crossing support structure to form a permanent attachment to said top portion of said crossing support structure;
a hook and loop fastener to secure said animal's neck to said animal transport cradle; and
a plurality of rubber support caps that are disposed on said ends of said crossing support structure to prevent said animal processing cradle from slipping or sliding, while being set on a surface.

12. The animal processing cradle according to claim 11, wherein said crossing support structure is made of heavy gauge aluminum tubing.

13. The animal processing cradle according to claim 11, wherein said support sheet is disposed across said top portion of said crossing support structure.

14. The animal processing cradle according to claim 11, wherein said support sheet includes 4 apertures positioned to approximate a position of a plurality of an animal's legs that are placed through said 4 apertures to help secure said animal in said animal transport cradle.

15. The animal according to claim 11, wherein a corresponding pair of slits is disposed on said support sheet.

16. The animal processing cradle according to claim 11, wherein said hook and loop fastener is a hook and loop strap.

17. The animal processing cradle according to claim 16, wherein said hook and loop strap is inserted through said corresponding pair of slits to comfortably and securely secure said animal's neck that is being transported by said animal transport cradle.

18. The animal processing cradle according to claim 11, wherein said surface is a ground surface.

19. The animal processing cradle according to claim 11, wherein said unfolded animal processing cradle is approximately 35 inches in length by approximately 4 inches in width and approximately 30 inches in height.

20. The animal processing cradle according to claim 11, wherein said animal processing cradle weighs approximately 6 pounds.
